(19) United States
(12) Patent Application Publication
(10) Pub. No.: US 2024/0265201 A1
(43) Pub. Date: Aug. 8, 2024

(54) DETERMINING APPARATUS, DETERMINING METHOD, AND PROGRAM

(71) Applicant: NIPPON TELEGRAPH AND TELEPHONE CORPORATION, Tokyo (JP)

(72) Inventors: Fumika ASAI, Musashino-shi, Tokyo (JP); Norio YAMAMOTO, Musashino-shi, Tokyo (JP); Haruhisa NOZUE, Musashino-shi, Tokyo (JP); Shunsuke KANAI, Musashino-shi, Tokyo (JP); Kenichi TAYAMA, Musashino-shi, Tokyo (JP)

(73) Assignee: NIPPON TELEGRAPH AND TELEPHONE CORPORATION, Tokyo (JP)

(21) Appl. No.: 18/565,097

(22) PCT Filed: Jun. 2, 2021
(86) PCT No.: PCT/JP2021/020971

§ 371 Date: Nov. 29, 2023

(51) Int. Cl. G06F 40/247; G06F 40/253; G06F 40/279

(52) U.S. Cl. CPC G06F 40/247; G06F 40/253; G06F 40/279

(57) ABSTRACT

A judgement device according to an embodiment includes an acquisition unit, a determination unit, a judgement unit, and an update unit. The acquisition unit acquires data of a sentence consists of at least two words. The determination unit determines a verb and an object word from among words included in the data. The judgement unit refers to group label information indicating which of a verb or an object word a word included in a label representing a sentence representative of a group including one or more sentences having the same meaning corresponds to, and judges which label a synonym of the determined verb and a synonym of the object word correspond to. The update unit associates a sentence with a judged label and updates the group label information when it is possible to judge which label a synonym of a verb and a synonym of an object word correspond to.

### TECHNICAL FIELD

The embodiment relates to a judgement device, a judgement method, and a program.

### BACKGROUND ART

In general, information is registered for a certain event by a sentence, and it is sometimes desired to access the event through the sentence in order to understand contents of the event later. When a large number of sentences and events are registered in this way, since the event is accessed by using the sentences as a key, it is desirable that the registered information and the event coincide with each other.

### CITATION LIST

### Patent Literature

[PTL 1] Japanese Patent Application Publication No. 2018-028778

### SUMMARY OF INVENTION

### Technical Problem

However, there is a notation fluctuation in a sentence which is registered information, and a desired event may not be accessed through the sentence.

An embodiment provides a judgement device, a judgement method, and a program that can interpret a plurality of sentences having similar meanings into the same sentence even if the plurality of sentences is registered.

### Solution to Problem

A judgement device of an embodiment includes an acquisition unit, a determination unit, a judgement unit, and an update unit. The acquisition unit acquires data of a sentence consists of at least two words. The determination unit determines a verb and an object word from words included in the data. The judgement unit refers to group label information in which a word included in a label representing a sentence representative of a group including one or more sentences having the same meaning indicates which of a verb and an object word, and judges which label a synonym of the determined verb and a synonym of the object word correspond to. The update unit associates the sentence with the judged label and updates the group label information when it can be judged which label the synonym of the verb and the synonym of the object word correspond to.

### Advantageous Effects of Invention

In an embodiment, even if a plurality of different sentences having similar meanings are registered, they can be interpreted into the same sentence.

### BRIEF DESCRIPTION OF DRAWINGS

FIG. 1 is a diagram showing a hardware configuration of a similarity judgement device according to an embodiment.

FIG. 2 is a diagram showing a function of the similarity judgement device according to a first embodiment.

FIG. 3 is a flowchart showing an example of an operation of the similarity judgement device shown in FIG. 2.

FIG. 4 is a diagram showing an example of information included in a group label DB shown in FIG. 2.

FIG. 5 is a diagram showing an example of information included in a synonym frequency DB shown in FIG. 2.

FIG. 6 is a diagram showing information included in the synonym frequency DB used in an example 1.

FIG. 7 is a diagram showing information included in the group label DB (coping method DB) used in the example 1.

FIG. 8 is a diagram showing information included in the group label DB (coping method DB) updated in the example 1.

FIG. 9 is a diagram showing information included in the synonym frequency DB updated in the example 1.

FIG. 10 is a diagram showing information included in the synonym frequency DB used in an example 2.

FIG. 11 is a diagram showing information included in the group label DB (coping method DB) used in the example 2.

FIG. 12 is a diagram showing information included in the synonym frequency DB used in an example 3.

FIG. 13 is a diagram showing information included in the group label DB (coping method DB) used in the example 3.

FIG. 14 is a diagram showing information included in the group label DB (coping method DB) updated in the example 3.

FIG. 15 is a diagram showing information included in the synonym frequency DB updated in the example 3.

FIG. 16 is a diagram showing a function of a similarity judgement device according to a second embodiment.

FIG. 17 is a flowchart showing an example of an operation of the similarity judgement device shown in FIG. 16.

FIG. 18 is a diagram showing information included in the synonym frequency DB updated in the example 2.

FIG. 19 is a diagram showing information included in the group label DB (coping method DB) updated in the example 2.

### DESCRIPTION OF EMBODIMENTS

The following describes a judgement device, a judgement method, and a program according to an embodiment based on the figures.

### (Overview)

There is a technique that extracts a combination of unique failure events for each failure case so as not to overlap with registered failure cases from database in which failure cases of a network are registered, and automatically creates and corrects a rule capable of judging a failure factor location as a characteristic failure event.

In the already operated network, it is necessary to register failure information from the past failure history information in order to generate this rule. The failure history information includes, for example, a failure location, a failure cause, and a method of coping with the failure.

In this coping method, even when the same operation is performed for a failure, a sentence expressing the coping method may include a notation fluctuation due to a difference of a registrant or the like.

In the present embodiment, as an example where information about an event associated with a sentence is registered, and the event may be accessed through the sentence in order to understand the contents of the event later, it is described by taking a coping method in the failure history information of the network.

In the following embodiment, a manner in which a notation fluctuation occurs in a sentence describing a coping method included in the failure history information will be described in detail as an example. However, the following embodiments are merely examples, and this application is not applicable only to the coping method included in the failure history information of the network. This application is widely applicable to the case where information is registered in association with a sentence for a certain event and the event is accessed through the sentence to understand the contents of the event later.

### First Embodiment

### (Hardware Configuration)

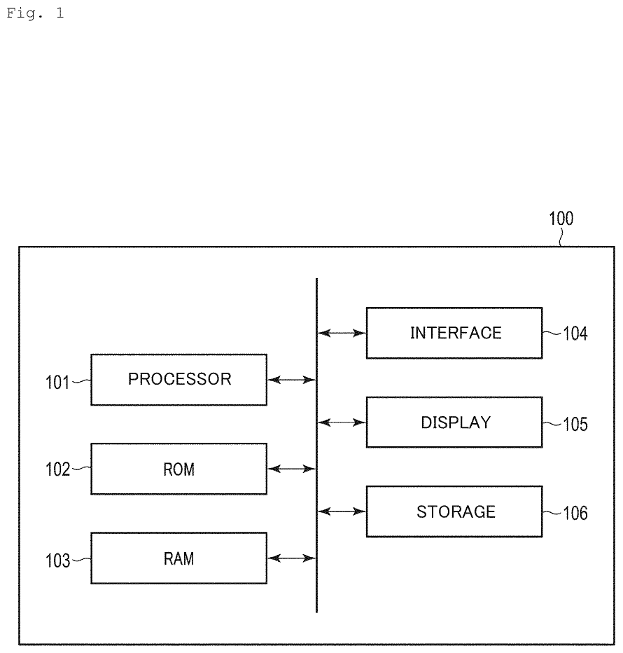

An example of a hardware configuration of a similarity judgement device (simply referred to as a judgement device) of the present embodiment will be described with reference to FIG. 1.

The similarity judgement device 100 of the present embodiment includes a processor 101, a ROM 102, a RAM 103, an interface 104, a display 105 and a storage 106.

The processor 101 is a processing device for controlling an entire of the similarity judgement device 100. The processor 101 is a CPU (Central Processing Unit), for example. The processor 101 is not limited to the CPU. In addition, ASIC (Application Specific IC) or the like may be used instead of the CPU. There may be two or more processors 101 instead of one.

The ROM 102 is a read-only storage device. The ROM 102 stores firmware and various types of programs necessary for operation of the similarity judgement device 100.

The RAM 103 is a storage device in which data can be arbitrarily written. The RAM 103 is used as a work area for the processor 101, and temporarily stores the firmware and the like held in the ROM 102.

The interface 104 is a device for exchanging information with outside devices. The interface 104 receives, for example, text data. In addition, the interface 104 transmits information to an outside server or the like.

The display 105 is a display device that displays various types of screens. The display 105 may be a liquid crystal display, an organic EL display, or the like. Also, the display 105 may be provided with a touch panel.

The storage 106 is a storage device such as a hard disk. The storage 106 stores, for example, various types of applications executed by the processor 101, data of an input of the application and data obtained by execution of the application.

### (Functional Configuration)

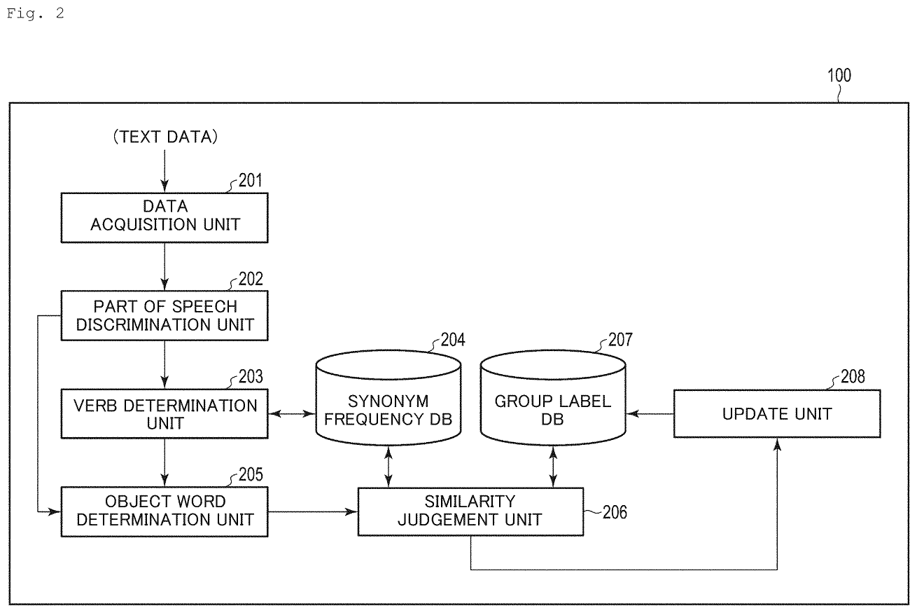

Next, an example of a function of the similarity judgement device 100 of the present embodiment will be described with reference to FIG. 2.

The similarity judgement device 100 of the present embodiment includes, as functional blocks, a data acquisition unit 201, a part of speech judgement unit 202, a verb determination unit 203, a synonym frequency DB (hereinafter, database is abbreviated as DB) 204, an object word determination unit 205, a similarity judgement unit 206, a group label DB 207, and an update unit 208. The data acquisition unit 201 is realized by, for example, the interface 104. The part of speech judgement unit 202, the verb determination unit 203, the object word determination unit 205, the similarity judgement unit 206, and the update unit 208, for example, are realized by the processor 101, the ROM 102, the RAM 103 and the storage 106. The synonym frequency DB 204 and the group label DB 207 are realized by, for example, the storage 106.

The data acquisition unit 201 receives text data. The text data includes data of a sentence indicating certain contents (hereinafter, “data of sentence” abbreviated as “sentence”), and includes, for example, a sentence describing a coping method. The sentence consists of at least two words and includes a verb and an object word.

The part of speech judgement unit 202 judges a part of speech of a word included in the sentence acquired by the data acquisition unit 201. The part of speech judgement unit 202 performs syntax analysis (for example, morphological analysis) of the sentence. The part of speech judgement unit 202 decomposes the sentence into the minimum significant words by the morphological analysis. The part of speech judgement unit 202 judges whether the word is a noun or not for each word. Note that the part of speech judgement unit 202 may judge whether the word is a verb or not for each word, or may judge whether the word is a verb, a noun, or other part of speech (for example, an adjective or a postpositional particle).

The synonym frequency DB 204 includes synonym frequency information indicating a frequency of use for each synonym. The synonym frequency DB 204 includes, as synonym frequency information, for example, a synonym of a verb, a synonym of an object word, a first frequency and a second frequency attached to each synonym. The first frequency includes a frequency of a verb in which a certain synonym is used as the verb, and a frequency in which the synonym is used as the object word. The second frequency is a sum of the first frequencies of the synonym included in the synonym group for each group of one or more words (called a synonym group) to be the synonym. The second frequency is the sum of the first frequencies of verbs in which the synonym is used as the verb (also referred to as the second frequency of verbs), and the sum of the first frequencies of the object words in which the synonym is used as the object word (also referred to as the second frequency of the object word). The synonym frequency DB 204 may be prepared in advance, or may be modified by the manner described in the second embodiment. In addition, the synonym frequency DB 204 may be registered in the manner described in the second embodiment without registering anything at first.

The verb determination unit 203 determines the verb from words included in the sentence. The verb determination unit 203 determines the word as the verb when there is only one word judged to be the verb by the morphological analysis by the part of speech judgement unit 202. When it is judged that all the words are not verbs by the syntax analysis by the part of speech judgement unit 202 or it is judged that two or more words are verbs, the verb determination unit 203 determines the verb as follows. The verb determination unit 203 refers to the synonym frequency DB 204 and calculates the second frequency of a synonym group to which the word belongs for each word. Then, the verb determination unit 203 determines a word having the largest second frequency of verb as the verb among the second frequencies.

The object word determination unit 205 determines the object word from words included in the sentence. The object word determination unit 205 performs syntax analysis of the sentence and determines a word to be the object word from the remaining words when the part of speech judgement unit 202 judges that the word is the verb.

When one word is judged to be the verb by the morphological analysis by the verb determination unit 203 and two or more words are judged to be nouns by the part of speech judgement unit 202, the object word determination unit 205 may determine the object word as follows. The object word determination unit 205 refers to the synonym frequency DB 204 and calculates the second frequency of a synonym group to which the word belongs for each word. Then, the object word determination unit 205 determines a word having the largest second frequency of the object word as the object word among the second frequencies.

The group label DB 207 includes a label representing a sentence representative of a group (called a sentence group) including one or more sentences having the same meaning, and group label information associating one or more sentences having the same meaning with each other. The group label DB 207 associates and stores, as group label information, for example, a label, an object word label which is the object word included in the label, a verb label which is the verb included in the label, one or more sentences having the same meaning included in the sentence group of the label, the verb included in the sentence, and the object word included in the sentence with each other. The one or more sentences having the same meaning included in the sentence group are one or more sentences included in the one or more text data acquired by the data acquisition unit 201.

The similarity judgement unit 206 judges which label included in the group label DB 207 the synonym of the verb determined by the verb determination unit 203 corresponds to. Further, the similarity judgement unit 206 judges which label included in the group label DB 207 the synonym of the object word determined by the object word determination unit 205 corresponds to. The similarity judgement unit 206 selects the verb labels, by the number of matching labels, in which the synonym of the verb determined by the verb determination unit 203 matches the verb label included in the group label DB 207. Then, the similarity judgement unit 206 selects the object word labels, by the number of matching labels, in which the synonym of the object word determined by the object word determination unit 205 matches the object word label included in the group label DB 207.

Thereafter, the similarity judgement unit 206 refers to the verb label selected to match and the object word label selected to match, and retrieves the verb label and the object word label associated with the same label. The similarity judgement unit 206 associates and extracts the verb label and the object word label associated with the same label, the label, the sentence acquired by the data acquisition unit 201, the object word of the sentence, and the verb of the sentence with each other. Although the same label is not limited to one, and there is a plurality of labels, the similarity judgement unit 206 extracts all the same labels. Further, the similarity judgement unit 206 may perform processing so as to present the effect when there is no same label (details are described in the second embodiment).

The update unit 208 associates the sentence included in the text data acquired by the data acquisition unit 201 with the label judged by the similarity judgement unit 206, and updates the group label DB 207. The update unit 208 associates, for example, the sentence, the verb determined by the verb determination unit 203, the object word determined by the object word determination unit 205, and a label judged to correspond to the synonym of the verb and the synonym of the object word by the similarity judgement unit 206, and adds the associated information to the group label DB 207 when the associated information is not included in the group label DB 207. Note that the update unit 208 may update the group label DB 207 including not only the label but also the verb label and the object word label.

Further, when newly adding the sentence included in the text data acquired by the data acquisition unit 201 to the group label DB 207, since words (verbs and object words) included in the sentence are in a word list of the synonym frequency DB 204, the update unit 208 updates the synonym frequency DB 204 by incrementing by the number of times of appearance of the words.

### (Similarity Judgement Processing)

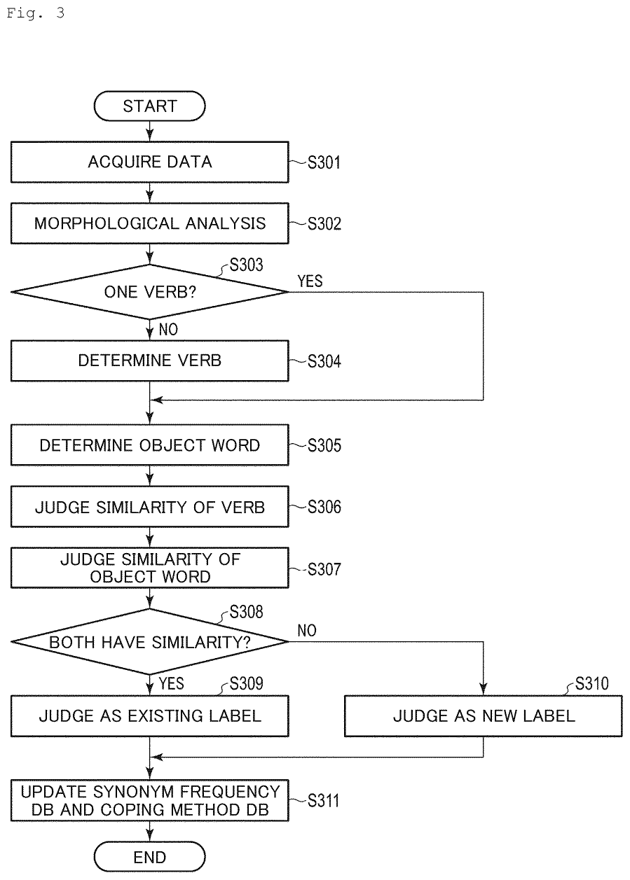

Next, a processing step of judging the similarity by the similarity judgement device 100 will be described with reference to FIG. 3.

In a step S301, the data acquisition unit 201 acquires text data including the sentence.

In a step S302, the part of speech judgement unit 202 performs the morphological analysis of the sentence.

In a step S303, the part of speech judgement unit 202 judges whether or not one verb exists in words included in the sentence. When the part of speech judgement unit 202 judges that there is one verb included in the text data, the processing proceeds to a step S305, and when the part of speech judgement unit 202 judges that the verb included in the text data is not one, the processing proceeds to a step S304.

In the step S304, the verb determination unit 203 determines the verb included in the sentence. When it is judged that no verb is included in the sentence, the verb determination unit 203 may stop the similarity judgement processing and receive other text data. The verb determination unit 203 may determine the verb by referring to the synonym frequency DB 204.

In the step S305, the object word determination unit 205 determines the object word from words other than the verb included in the sentence. The object word determination unit 205 may determine the verb by referring to the synonym frequency DB 204.

In a step S306, the similarity judgement unit 206 extracts the synonym of the verb determined by the verb determination unit 203 from the synonym frequency DB 204, and judges whether any of the extracted synonyms match any of the verb labels included in the group label DB 207.

In a step S307, the similarity judgement unit 206 extracts the synonym of the object word determined by the object word determination unit 205 from the synonym frequency DB 204, and judges whether any of the extracted synonyms match any of the object word labels included in the group label DB 207. Note that since the results obtained even when either of the steps S306 and S307 is executed first are the same, either of the steps may be performed first.

In a step S308, the similarity judgement unit 206 judges whether or not there is a set in which the synonym of the verb and the verb label match each other and there is a set in which the synonym of the object word and the object word label match each other in the steps S306 and S307. The similarity judgement unit 206 proceeds to a step S309 when there is a matching set with respect to the verb and the object word, and proceeds to a step S310 when there is no matching set with respect to the verb or the object word.

In the step S309, the update unit 208 associates the sentence included in the text data acquired by the data acquisition unit 201 with an existing verb label, an existing object word label, and an existing label including these labels (judgement as an existing label). The update unit 208 may associate the verb and the object word with the label together with the sentence included in the text data.

In the step S310, since there is no verb label or object word label (or both labels) which can be associated with the sentence included in the text data, the update unit 208 judges that the label is a new label and records information of the sentence included in the text data. Note that an example of a modification of an operation prior to this step will be described in the second embodiment.

In a step S311, when proceeding from a step S309, an update unit 208 records information in which a sentence or the like included in the text data acquired by the data acquisition unit 201 is associated with an existing label in a group label DB 207 (coping method DB), The group label DB 207 is updated.

In the step S311, when the step is proceeded from the step S310, the update unit 208 records information of the sentence included in the text data acquired by the data acquisition unit 201 in the group label DB 207 as new information, and updates the group label DB 207.

Note that when the group label DB 207 is updated in the step S311, the update unit 208 newly adds the sentence included in the text data acquired by the data acquisition unit 201 to the group label DB 207. Since the words (verbs and object words) included in the sentence are in the word list of the synonym frequency DB 204, the update unit 208 updates the synonym frequency DB 204 by incrementing by the number of times of appearance of the words. For example, when the verb in the synonym frequency DB 204 newly appears once, the update unit 208 increments the number of times of appearance of the verb by one. As a result, in the synonym frequency DB 204, the total number of times of appearance of the synonym group to which the word belongs is also incremented by the incremented number. In the synonym frequency DB 204, the total number of times of appearance of the verb or the object word is incremented in response to whether the word is the verb or the object word.

### (Group Label DB 207)

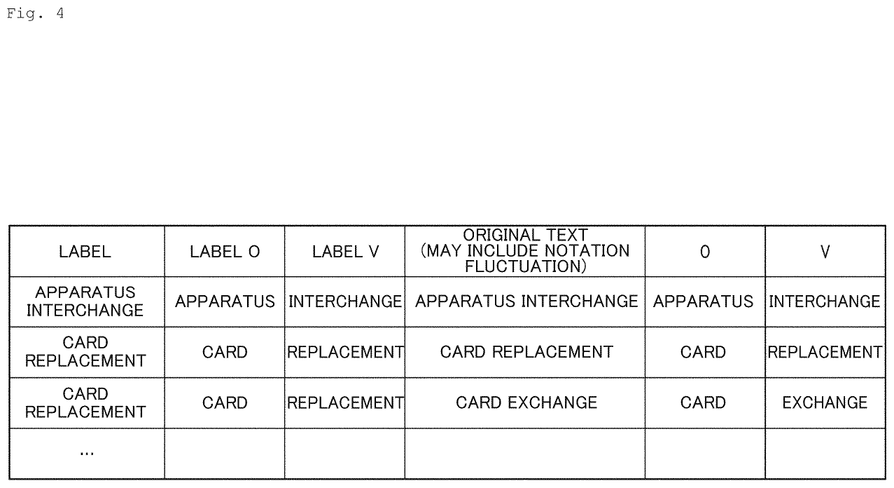

An example of information included in the group label DB 207 is described with reference to FIG. 4.

Three kinds of labels including “device replacement” are shown. In this example, the label indicates the coping method with a network failure. One object word label (displayed by label O) and one verb label (displayed by label V) are associated with each other for one label. One sentence (original text) included in the text data is associated for one label. Since the sentence can include a notation fluctuation, a plurality of sentences can be associated with the same label. In the example shown in FIG. 4, two kinds of “card replacement” as an original text and “card exchange” as an original text are associated with each other with respect to one kind of “card replacement” as a label. This example shows that there are two kinds of notation fluctuation of “card replacement” and “card replacement”, even though both have the same meaning as “card replacement”. In other words, the “card replacement” or the “card exchange” can be converted into the same “card replacement” expression. That is, when the group label DB 207 is used, the notation fluctuation can be absorbed.

### (Synonym Frequency DB 204)

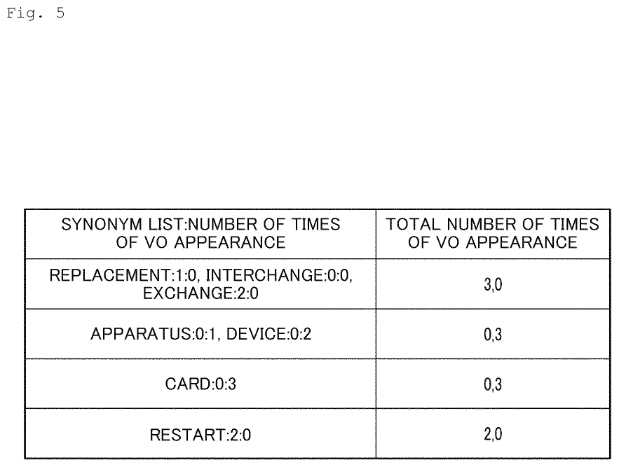

An example of information included in the synonym frequency DB 204 will be described with reference to FIG. 5.

In the synonym frequency DB 204, a word list to be synonym is grouped. In FIG. 5, words which are grouped as synonyms are described in the same column. A frequency indicating whether the word is used as the verb and a frequency indicating whether the word is used as the object word are described for each word to be the synonym. In the example shown in FIG. 5, the number of times the word appears as the verb and the number of times the word appears as the object word are adopted in a predetermined period as the frequency. For example, “replacement: 1: 0” (the number of times of appearance of VO) in FIG. 5 indicates that “replacement” appears once as the verb and 0 times as the object word. Note that the frequency (first frequency) may be a numerical value corresponding to the probability that the word is used as the verb or the object word, and is not limited to the number of times of appearance.

For each group of one or more words to be a synonym, the frequency indicating whether a word included in the group is used as the verb and the frequency indicating whether the word is used as the object word are described. In the example shown in FIG. 5, the total number of times of appearance of words included in the group as verbs and the total number of times of appearance of words included in the group as object words are adopted as frequencies. For example, “3, 0” (total number of times of appearance of VO) in two rows and two columns in FIG. 5 is a group including “replacement”, “interchange”, and “exchange”, it is shown that the verbs appear three times and 0 times as the object word. Note that the frequency (second frequency) may be a numerical value corresponding to the probability that any of the words included in the group is used, and is not limited to the total number of times of appearance of the words included in the group.

Further, the data whose frequency is determined according to the contents of the text data to be target may be changed. The contents of the synonym frequency DB 204 can be changed according to the contents of the target text data to be target. For example, the contents of the synonym frequency DB 204 may be changed depending on the kind of the network.

Next, three sentences included in the text data acquired by the data acquisition unit 201 are shown, and an example of each sentence will be specifically described. Note that each sentence indicates the coping method with the network failure.

### Example 1

An example 1 shows the case where the data acquisition unit 201 acquires a sentence indicating the coping method of “apparatus exchange”.

In a step S302, the part of speech judgement unit 202 performs the morphological analysis of “apparatus exchange”, and judges that the “apparatus” is a noun and the “exchange” is a noun. In this example, since the “apparatus” and the “exchange” are verbs or unknown, and an existence of one verb is unknown, the processing proceeds to a step S304.

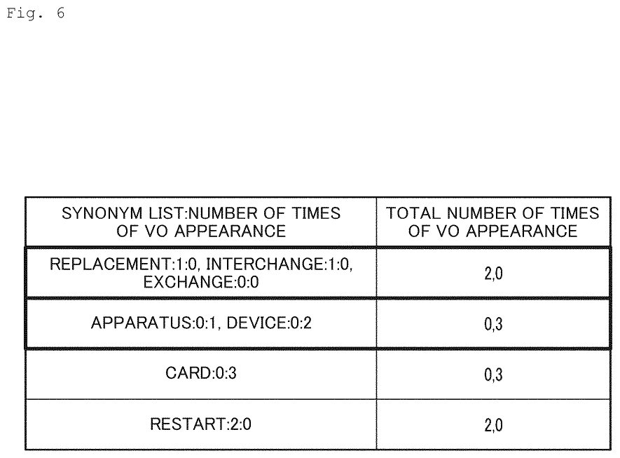

In the step S304, the verb determination unit 203 refers to the synonym frequency DB 204. The synonym frequency DB 204 of the example 1 is shown in FIG. 6. The verb determination unit 203 refers to the synonym frequency DB 204 in FIG. 6 to confirm that the frequency of verb (second frequency) is 0 in the synonym group to which the “apparatus” belongs and the frequency of verb is 2 in the synonym group to which the “exchange” belongs. As a result, the verb determination unit 203 determines that the “exchange” having a high frequency is the verb.

In a step S305, the object word determination unit 205 determines the object word for “exchange” already determined as the verb. In this example, the object word determination unit 205 confirms that only the “apparatus” is present as a word other than the “exchange”, and determines that the “apparatus” is the object word by the syntax analysis.

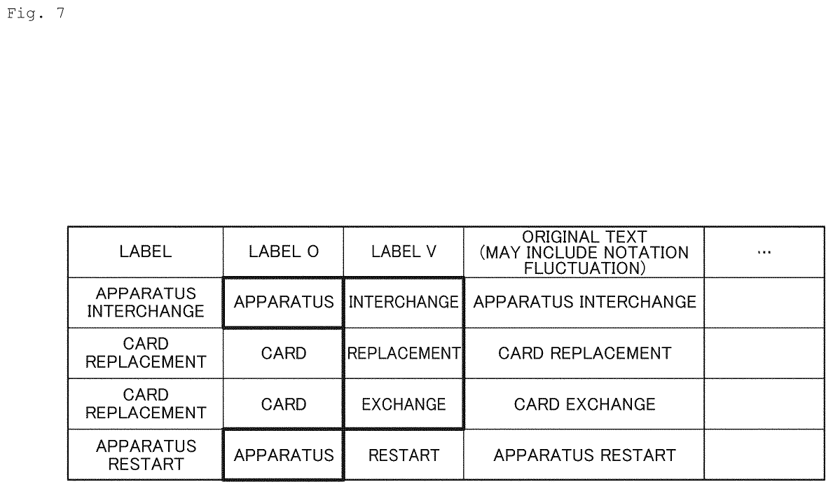

In a step S306, the similarity judgement unit 206 selects the word matching the verb label of the group label DB 207 shown in FIG. 7 among words (“replacement”, “interchange”, and “exchange”) included in the synonym group to which “exchange” judged as the verb belongs. In this example, the similarity judgement unit 206 judges that “interchange” and “replacement” shown in the thick frame of FIG. 7 are words matching the verb label.

In a step S307, the similarity judgement unit 206 selects the word matching the object word label of the group label DB 207 shown in FIG. 7 among words (“apparatus” and “device”) included in the synonym group to which the “device” judged as the object word belong. In this example, the similarity judgement unit 206 judges that the “apparatus” shown in the thick frame of FIG. 7 is a word matching the object word label.

In a step S308, the similarity judgement unit 206 retrieves a label in which “interchange” and “replacement” are verb labels and “apparatus” is an object word label in the group label DB 207. In this example, since the label “apparatus interchange” shown in FIG. 7 has the object word label “apparatus” and the verb label “interchange”, the similarity judgement unit 206 judges that the label “apparatus interchange” is the label of the coping method of “apparatus exchange”. In this example, since there is a set matching the verb and the object word, the processing proceeds to a step S309.

In the step S309, the update unit 208 associates “apparatus exchange” which is the sentence included in the text data acquired by the data acquisition unit 201 with an existing verb label “interchange”, an existing object word label “apparatus” and an existing label “apparatus exchange” including these labels (judgement as an existing label).

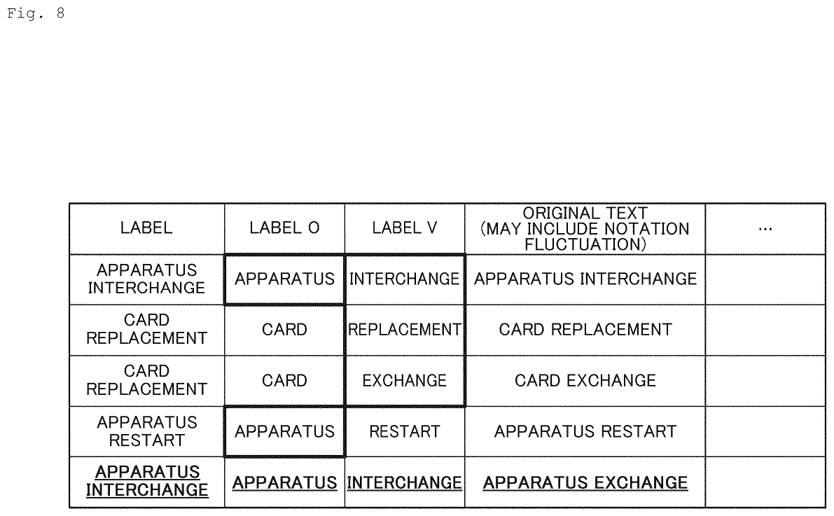

In a step S311, the update unit 208 adds information associating a label “apparatus interchange”, a label O “apparatus”, a label V “interchange”, and a sentence (original text) “apparatus exchange” in this example in the step S309 to the group label DB 207 like the underlined and bold description on the most bottom row shown in FIG. 8. Note that based on this meaning, the group label DB 207 is also referred to as a coping method DB.

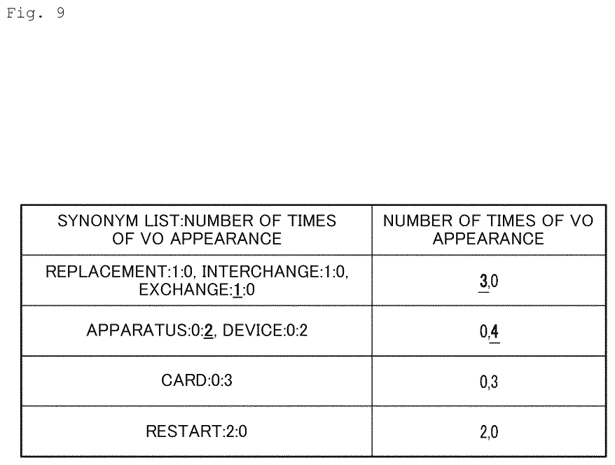

Further, in the step S311, an update unit 208 reflects an object word “apparatus” and a verb “interchange” included in “apparatus interchange” of the sentence (original text) added to the group label DB 207 in the synonym frequency DB 204. The update unit 208 increments the number of times of appearance of each of the object word “apparatus” and the verb “interchange” one by one. In the update unit 208, the number of times of appearance and the total number of times of appearance are incremented as shown by the underlined and bold numerals shown in FIG. 9. That is, as shown in FIG. 9, the numbers of times of VO appearance are incremented from the numbers of times of VO appearance shown in FIG. 6 so as to be “exchange: 1: 0”, “apparatus 0: 2”, and the total number of times of VO appearance is incremented to be “3, 0” and “0, 4” from the total number of times of VO appearance shown in FIG. 6.

### Example 2

An example 2 shows the case where the data acquisition unit 201 acquires a sentence indicating the coping method of “device exchange”.

In a step S302, the part of speech judgement unit 202 performs the morphological analysis to “device exchange”, and judges that the “device” is a noun and the “exchange” is a noun. In this example, the “apparatus device” and “exchange” are verbs or unknown, and since it is unknown whether the verb is one, the processing proceeds to a step S304.

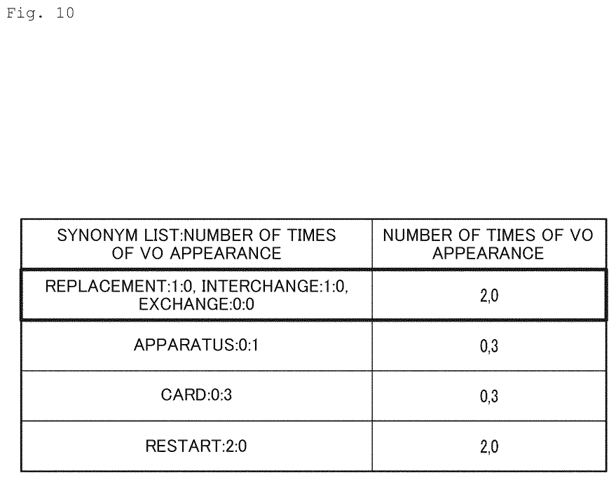

In the step S304, the verb determination unit 203 refers to the synonym frequency DB 204. The synonym frequency DB 204 of the example 2 is shown in FIG. 10. The verb determination unit 203 refers to the synonym frequency DB 204 shown in FIG. 10 to confirm that there is no synonym group to which the “device” belongs and that the synonym group to which the “exchange” belongs has the frequency of verbs of 2. As a result, the verb determination unit 203 determines the “exchange” having the frequency as the verb.

In a step S305, the object word determination unit 205 determines the object word for “exchange” already judged as the verb. In this example, the object word determination unit 205 confirms that only the “device” is present as a word other than the “exchange”, and determines that the “device” is the object word by the syntax analysis.

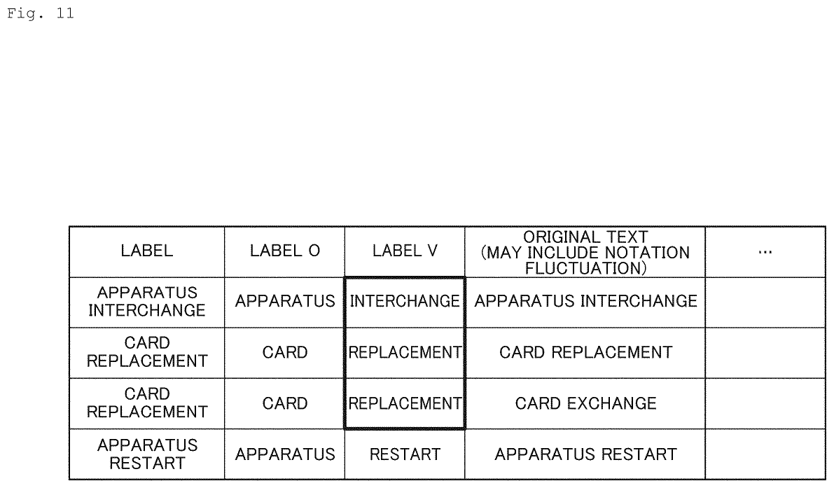

In a step S306, the similarity judgement unit 206 selects the words matching the verb label of the group label DB 207 shown in FIG. 11 among words (“replacement”, “interchange”, and “exchange”) included in the synonym group to which “exchange” judged as the verb belongs. In this example, the similarity judgement unit 206 judges that “interchange” and “replacement” shown in the thick frame of FIG. 11 are words matching the verb label.

In a step S307, the similarity judgement unit 206 confirms that there is no synonym group to which the “device” judged as the object word belongs.

In a step S308, the similarity judgement unit 206 retrieves a label in which “interchange” and “replacement” are the verb labels and “device” is the object word label in the group label DB 207. In this example, since there is no synonym group to which the “device” judged to be the object word belongs, the “device exchange” acquired by the data acquisition unit 201 has no matching set with respect to the verb and the object word, and the processing proceeds to a step S310.

In a step S310, since there is no label which can be associated with the sentence included in the text data, the update unit 208 judges that the label is a new label and records information of the sentence included in the text data. Note that operations prior to this step will be described in the second embodiment.

### Example 3

An example 3 shows the case where the data acquisition unit 201 acquires a sentence indicating the coping method of “apparatus replacement and recovery confirmation”.

In a step S302, the part of speech judgement unit 202 performs the morphological analysis of “apparatus replacement and recovery confirmation”, and judges that the “apparatus” is a noun, the “replacement” is a verb, the “recovery” is a noun and the “confirmation” is a verb. Since there are two verbs in this example, the processing proceeds to a step S304.

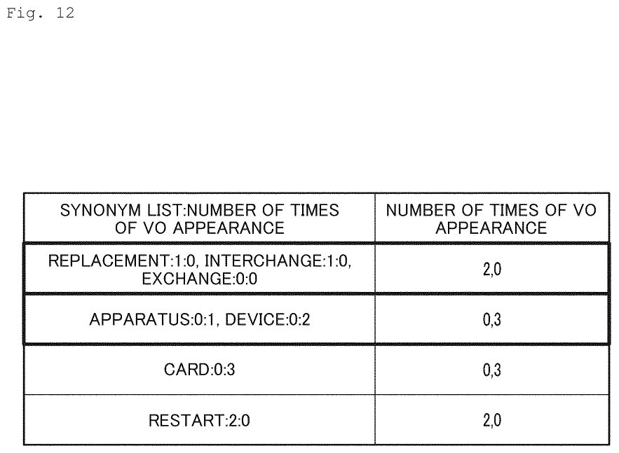

In the step S304, the verb determination unit 203 refers to the synonym frequency DB 204. The synonym frequency DB 204 of the example 3 is shown in FIG. 12. The verb determination unit 203 refers to the synonym frequency DB 204 shown in FIG. 12, and confirms that the frequency of verb (second frequency) is 2 in the synonym group to which “replacement” belongs, and the synonym group to which “confirmation” belongs does not exist. As a result, the verb determination unit 203 determines that the “replacement” having some frequencies is the verb.

In a step S305, the object word determination unit 205 determines an object word for “replacement” already determined as the verb. In this example, the object word determination unit 205 determines that the object word of “replacement” is the “apparatus” by the syntax analysis.

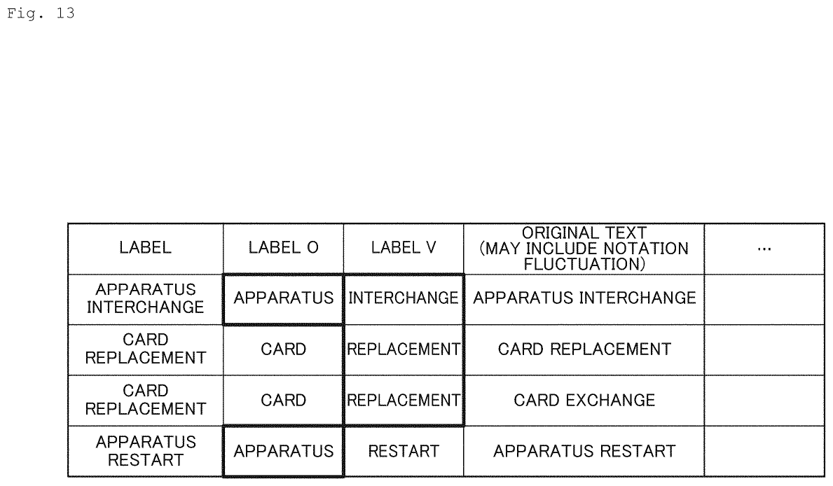

In a step S306, the similarity judgement unit 206 selects the words matching the verb label of the group label DB 207 shown in FIG. 13 among words (“interchange”, “replacement”, and “exchange”) included in the synonym group to which “interchange” judged as the verb belongs. In this example, the similarity judgement unit 206 judges that “interchange” and “replacement” shown in the thick frame of FIG. 13 are words matching the verb label.

In a step S307, the similarity judgement unit 206 selects the words matching the object word label of the group label DB 207 shown in FIG. 13 among words (“apparatus” and “device”) included in the synonym group to which the “apparatus” judged as the object word belongs. In this example, the similarity judgement unit 206 judges that the “apparatus” shown in the thick frame of FIG. 13 is a word matching the object word label.

In a step S308, the similarity judgement unit 206 retrieves a label in which “interchange” and “replacement” are the verb labels and “apparatus” is the object word label in the group label DB 207. In this example, since the label “apparatus interchange” shown in FIG. 13 has the object word label “apparatus” and the verb label “interchange”, the similarity judgement unit 206 judges that the “apparatus interchange” is a label of the coping method of “apparatus replacement and recovery confirmation”. In this example, since there is a set matching the verb and the object word, the processing proceeds to a step S309.

In a step S309, the update unit 208 associates “apparatus replacement and recovery confirmation” which is a sentence included in the text data acquired by the data acquisition unit 201 with an existing verb label “interchange”, an existing object word label “apparatus”, and an existing label “apparatus interchange” including these labels (judgement as an existing label).

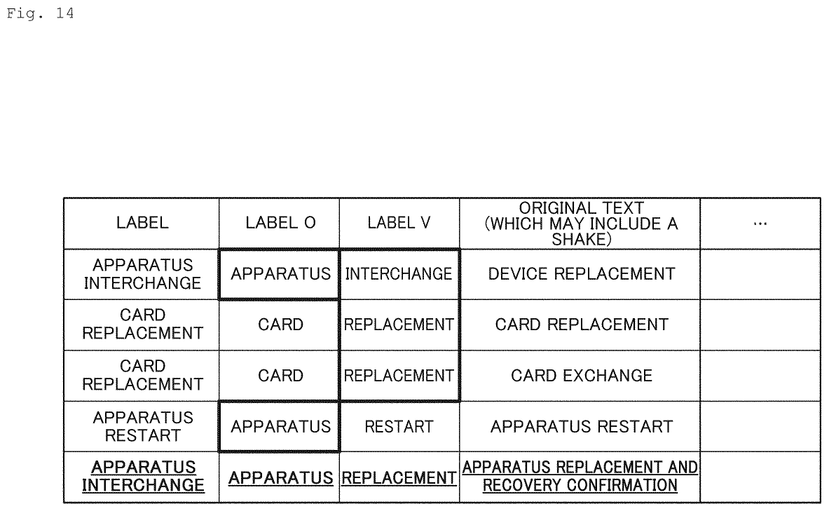

In a step S311, the update unit 208 adds information associating a label “apparatus interchange”, a label O “apparatus”, a label V “interchange”, and a sentence (original text) “apparatus replacement and recovery confirmation” with each other in this example in the step S309 like the underlined and bold description in the most bottom row shown in FIG. 14 to the group label DB 207.

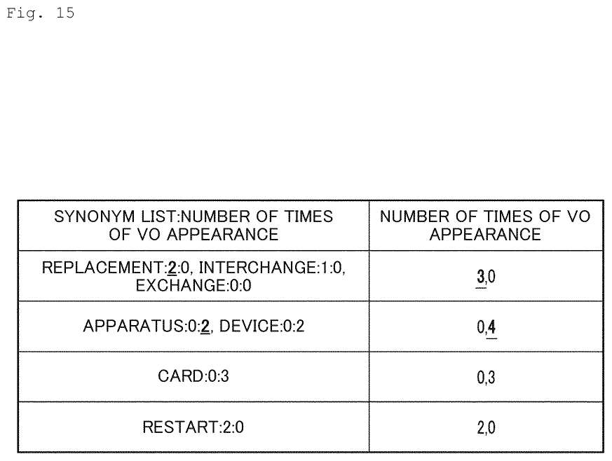

Further, in the step S311, the update unit 208 reflects the object word “apparatus” and the verb “replacement” included in “apparatus replacement and recovery confirmation” of the sentence (original text) added to the group label DB 207 to the synonym frequency DB 204. The update unit 208 increments the number of times of appearance of the object word “apparatus” and the verb “replacement” one by one. In the update unit 208, the number of times of appearance and the total number of times of appearance are incremented as shown by the underlined and bold numerals shown in FIG. 15. That is, as shown in FIG. 15, the numbers of times of VO appearance are incremented to be “replacement: 2: 0” and “apparatus: 0: 2” from the numbers of times of VO appearance shown in FIG. 12, and each total number of times of VO appearance is incremented to be “3, 0” and “0, 4” from the total number of times of VO appearance shown in FIG. 12.

The similarity judgement device according to the first embodiment described above can, even if there is a plurality of different sentences having the same meaning, extract the label corresponding to the sentence and interpret the label as the sentence corresponding to the label by using the verb and the object word included in the sentence as keys on the basis of the synonym frequency information and the group label information, and can access exact information. Further, according to the present embodiment, by judging the label corresponding to the sentence, the group label information and the synonym frequency information are automatically updated, and the database including the group label information and the synonym frequency information can be improved and the accuracy can be improved.

According to the present embodiment, for example, even if there is the notation fluctuation in the sentence describing the coping method recorded when coping with a failure, this sentence can be converted into the same sentence. Therefore, according to the present embodiment, even if there is the notation fluctuation in the sentence describing the coping method, desired information related to the coping method can be accessed. As a result, according to the present embodiment, it is possible to automatically update the database in which the coping method (and the synonym frequency information) is written without notation fluctuation, and to improve the accuracy of the coping method.

### Second Embodiment

### (Functional Configuration)

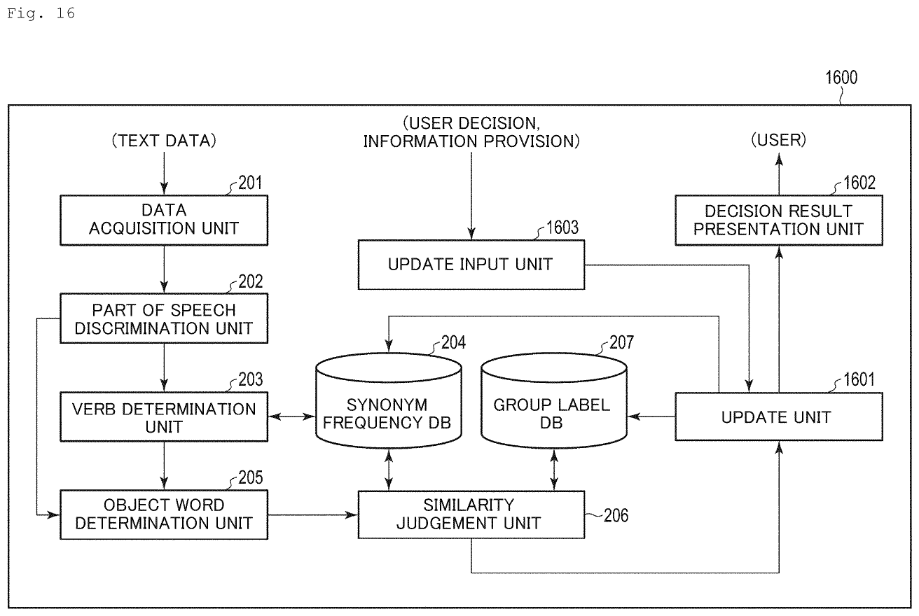

An example of a functional configuration of a similarity judgement device 1600 according to a second embodiment will be described with reference to FIG. 16. Note that since the hardware configuration of the similarity judgement device 1600 is the same as that of the similarity judgement device 100 of the first embodiment, description thereof is omitted.

In addition to the similarity judgement device 100 of the first embodiment, the similarity judgement device 1600 of the present embodiment further includes, as functional blocks, a decision result presentation unit 1602 and an update input unit 1603. However, the update unit 208 of the first embodiment is changed to the update unit 1601. Note that the blocks assigned the same reference numerals as those of the blocks according to the first embodiment among the other blocks have basically the same configuration and operation, and the description thereof is omitted.

The update unit 1601 is implemented by, for example, a processor 101, a ROM 102, a RAM 103, and a storage 106. The decision result presentation unit 1602 is implemented by, for example, the processor 101 and a display 105. The update input unit 1603 is implemented by, for example, an interface 104.

The update unit 1601 includes the following functions in addition to the operation of the update unit 208 of the first embodiment. The update unit 1601 transmits the updated information of the group label DB 207 and new information (for example, a sentence corresponding to a new coping method) not included in the group label DB 207 to the decision result presentation unit 1602. In addition, the update unit 1601 transmits the existing label in which the similarity judgement unit 206 judges that the verb label and the object word label are associated with the same label, and the sentence acquired by the data acquisition unit 201 to the decision result presentation unit 1602.

The update unit 1601 receives a provision of decision information from the outside of this device (for example, user or recognition device) or other information from the outside of this device by the contents presented by the decision result presentation unit 1602. The update unit 1601 acquires information or the like of these decisions (decision information and other information), and associates the sentence acquired by the data acquisition unit 201 and the label to be registered in the group label DB 207 on the basis of the information or the like to register in the group label DB 207. The decision information or the like includes information on whether or not the known label judged by the similarity judgement unit 206 matches the sentence acquired by the data acquisition unit 201. In addition, when the known label does not match the sentence, the decision information or the like includes information for designating the label matching the sentence. The case where the known label does not match the sentence is the case where the similarity judgement unit 206 judges that the object word label or the verb label corresponding to at least one synonym of the object word or the verb included in the sentence is not present in the group label DB 207.

Further, the update unit 1601 adds the verb or the object word to the corresponding synonym group and updates the synonym frequency DB 204 when the verb or the object word included in the sentence is not registered in the synonym frequency DB 204 on the basis of the decision information or the like. In this case, the decision information or the like includes information for designating the label included in the group label DB 207 corresponding to the sentence acquired by the data acquisition unit 201. In addition to this, when there is no label corresponding to the sentence acquired by the data acquisition unit 201 in the label included in the group label DB 207, the decision information or the like includes information indicating that the label is not registered, and information for designating a label to be newly registered. Further, the update unit 1601 adds the verb or the object word which are not registered in the synonym frequency DB 204 included in the sentence corresponding to the designated label to the synonym group and updates the synonym frequency DB 204.

The update unit 1601 sets a first frequency (VO appearance frequency) corresponding to the added verb or object word to a predetermined value (for example, 1), and increments a second frequency (VO appearance frequency total number) corresponding to the added verb or object word by a predetermined value (for example, 1).

The decision result presentation unit 1602 presents the information received from the update unit 1601 to the outside of the similarity judgement device 1600 (for example, a user or a recognition device). The recognition device is a device that can recognize the information presented by the decision result presentation unit 1602.

The update input unit 1603 receives the information presented by the decision result presentation unit 1602, receives new information which is decided by the outside device or the like (for example, a user or a recognition device and a decision device) and to be registered in the synonym frequency DB 204 or the group label DB 207 and transmits the new information to the update unit 1601. The decision device is a device capable of deciding information to be transmitted to the update input unit 1603 on the basis of information recognized by the recognition device. Further, when the outside device or the like decides that the information is not changed and as it is in response to the information presented by the decision result presentation unit 1602, the update input unit 1603 transmits the information without change to the update unit 1601 because there is no new information.

### (Similarity Judgement Processing)

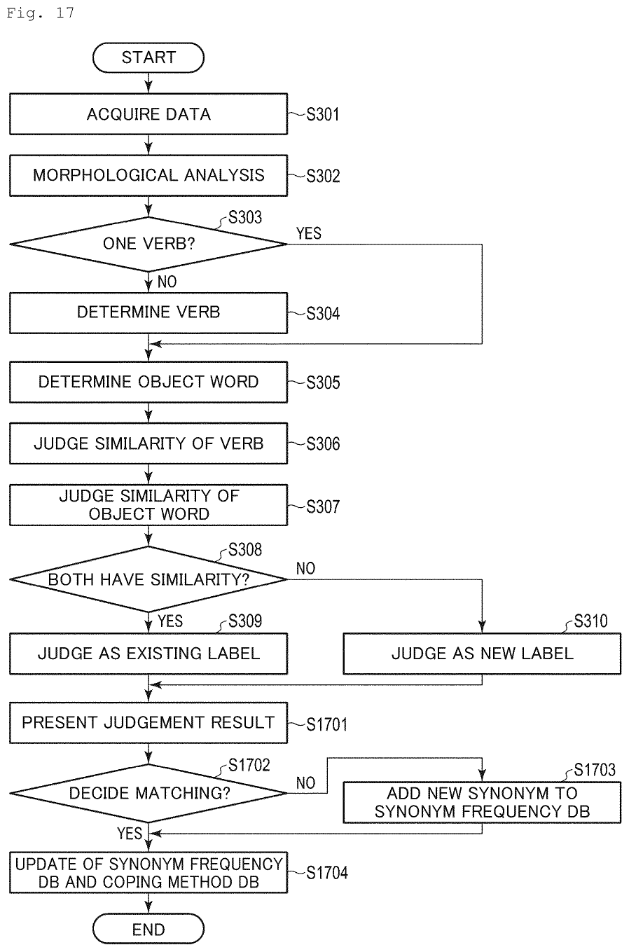

Next, processing steps of judging the similarity by the similarity judgement device 1600 will be described with reference to FIG. 17. Note that steps having the same numerals as those in the first embodiment are basically the same operations, and the description thereof is omitted.

In a step S1701, when the step is proceeded from the step S309, the decision result presentation unit 1602 presents information in which an existing verb label, an existing object word label, and an existing label including these labels are associated with the sentence included in the text data acquired by the data acquisition unit 201.

In the step S1701, when the step is proceeded from the step S310, the decision result presentation unit 1602 presents information on the sentence included in the text data acquired by the data acquisition unit 201, information indicating that the sentence corresponds to a new label, and information included in the group label DB 207.

In a step S1702, the update input unit 1603 receives the contents decided by the outside device or the like or information based on the decision on the basis of the information presented by the decision result presentation unit 1602. In the step S1702, when passing through the step S309 and when the information which is received by the update input unit 1603 indicates that information associating the existing label with the sentence is correct, the update unit 1601 decides that the existing label and the sentence are “matched” and the processing proceeds to a step S1704, and when the associated information indicates not correct, the update unit 1601 decides that the existing label and the sentence does not “match” and the processing proceeds to a step S1703. Further, in the step S1702, when the information received by the update input unit 1603 corresponds to a new label of the sentence (when passing through the step S310), the update unit 1601 decides that the existing label and the sentence does not “match”, and the processing proceeds to the step S1703. Note that when passing through the step S310, a label corresponding to the sentence may exist or may not exist in the group label DB 207.

In the step S1703, the update unit 1601 adds at least one of verbs or object words of the synonym not registered in the synonym frequency DB 204 included in the sentence corresponding to the designated label received from an update input unit 1603 to the synonym group of the synonym frequency DB 204.

In a step S1704, when passing through only the step S1702, the update unit 1601 registers the existing verb label, the existing object word label and the existing label including these labels, and information associating sentences included in the text data acquired by the data acquisition unit 201 in the group label DB 207 (coping method DB), and updates the group label DB 207.

In the step S1704, when passing through the step S1703, the update unit 1601 register information associating a new label, a verb label and an object word label included in the new label, and the sentence included in the text data acquired by the data acquisition unit 201 in the group label DB 207 (coping method DB), and updates the group label DB 207.

Note that, when the group label DB 207 is updated in the step S1704, the update unit 1601 newly adds a sentence included in the text data acquired by the data acquisition unit 201 to the group label DB 207. Since the words (verbs and object words) included in the sentence are present in the word list of the synonym frequency DB 204, the update unit 1601 updates the synonym frequency DB 204 by incrementing by the number of times of appearance of the words. For example, when the verb in the synonym frequency DB 204 newly appears once, the update unit 1601 increments the number of times of appearance of the verb by one. As a result, in the synonym frequency DB 204, the total number of times of appearance of the synonym group to which the word belongs is also incremented by the incremented number. In the synonym frequency DB 204, the total number of times of appearance of the verb or the object word is incremented in response to whether the word is the verb or the object word.

### Example 2

The following description of the example 2 described in the first embodiment will be described below along with the description of the second embodiment described above. The example 2 shows a case where the data acquisition unit 201 acquires the sentence indicating the coping method of “device exchange”.

In a step S1701, the decision result presentation unit 1602 presents information (new coping method) indicating that the sentence of “device exchange” acquired by the data acquisition unit 201 has no label (object word label) corresponding to the group label DB 207 being the coping method DB, and current information included in the group label DB 207.

In a step S1702, the update input unit 1603 receives information corresponding to “apparatus interchange” which is the existing label registered in the group label DB 207. Also, in the step S1702, since the sentence corresponds to a new label (when passing through the step S310), the update unit 1601 decides that the information received by the update input unit 1603 is not “matched”, and the processing proceeds to the step S1703.

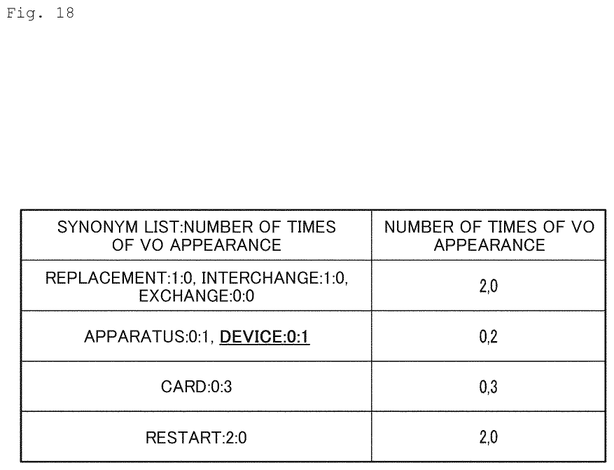

In a step S1703, as shown in the synonym frequency DB 204 shown in FIG. 18, the update unit 1601 adds a “device” which is the object word of the synonym not registered in the synonym frequency DB 204 included in a sentence corresponding to “apparatus interchange” which is a designated label received from the update input unit 1603 to the synonym group and updates the synonym frequency DB 204. Further, the update unit 1601 sets the first frequency (number of times of VO appearance) corresponding to the added object word “device” to 1 which is a predetermined value, and increments the second frequency (total number of times of VO appearance) corresponding to the added object word by 1 which is a predetermined value. As a result, as shown in FIG. 18, “device: 0: 1” (bold underlined portion shown in FIG. 18) is added, “the total number of times of VO appearance” is changed to “0, 2”, and the synonym frequency DB 204 is updated.

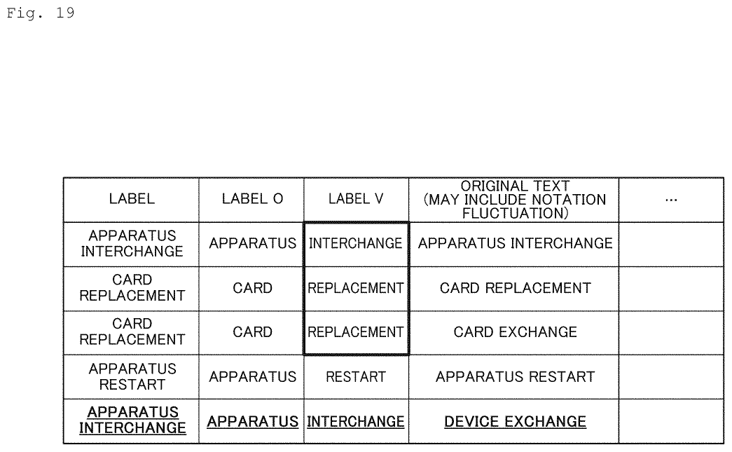

In a step S1704, as shown in the bold underlined portion shown in FIG. 19, the update unit 1601 registers information associating a label to be newly registered of “apparatus interchange”, the object word label “apparatus” and the verb label “interchange” included in the label, and the sentence “device exchange” included in the text data acquired by the data acquisition unit 201 with each other in the group label DB 207 (coping method DB) and updates the group label DB 207.

The similarity judgement device according to the second embodiment described above has the same effect as that of the first embodiment, even when the judgement device of the first embodiment cannot judge, the verb or the object word included in the sentence as the synonym of the verb label or the synonym of the object word label of the label corresponding to the sentence is registered in the synonym frequency DB and by adding a new label to the group label information, it is possible to extract the label corresponding to the sentence and interpret as the same sentence corresponding to the label, and it is possible to access the exact information. Further, according to the present embodiment, even when the judgement device of the first embodiment cannot judge, the label corresponding to the sentence can be judged, the group label information is automatically updated, thus, the database including the group label information can be improved and the accuracy can be improved.

### Modification Example

### <Verb Determination, Object Word Determination>

After the object word determination unit 205 determines the object word, the verb determination unit 203 may determine the verb.

The object word determination unit 205 determines the object word from words included in the sentence. The object word determination unit 205 determines the word as the object word when the part of speech judgement unit 202 judges that a word is the verb and there is only one remaining word. When the part of speech judgement unit 202 judges that two or more words are nouns by the morpheme analysis by the part of speech judgement unit 202, the object word determination unit 205 determines the object word as follows. The object word determination unit 205 refers to the synonym frequency DB 204 and calculates the second frequency of the synonym group to which the word belongs for each word. Then, the object word determination unit 205 determines a word having the largest second frequency of the object word as the object word among the second frequencies.

Thereafter, the verb determination unit 203 determines the verb from the words included in the sentence. The verb determination unit 203 determines the word as the verb when there is only one word judged to be not a noun by the morphological analysis by the part of speech judgement unit 202. Further, the verb determination unit 203 may perform the syntax analysis for the sentence and determine a word to be the verb from the remaining words when the part of speech judgement unit 202 judges that a certain word is the object word.

### <Addition of Label>

The update input unit 1603 may receive a label which can be included in the group label DB 207, and the update unit 1601 may add the label to the group label DB 207. For example, when neither the verb label nor the object word label corresponding to the sentence acquired by the data acquisition unit 201 are present in the group label DB 207, the update unit 1601 may add a new label received by the update input unit 1603 to the group label DB 207.

### <Modification of Label>

The decision result presentation unit 1602 may present the contents of the group label DB 207, the update input unit 1603 may accept the correction of the contents, and the update unit 1601 may correct the contents of the group label DB 207.

### <Syntax Analysis>

The syntax analysis used by the part of speech judgement unit 202 or the object word determination unit 205 includes the morphological analysis, but is not limited to this. The syntax analysis may use a structure grammar, a lexical functional grammar. In addition, the syntax analysis may also use statistical manners. The statistical manners are utilized for the syntax analysis, for example, using training data specialized in a particular term field. When the verb determination unit 203 performs the syntax analysis, the same syntax analysis is used.

### <Synonym Frequency DB 204>

The failures may be classified into a plurality of categories, and a synonym frequency DB specific to the category may be present for each category.

### <Synonym Frequency DB 204, Group Label DB 207>

At least one of the synonym frequency DB 204 and the group label DB 207 is not included in the similarity judgement devices 100 and 1600, and may be outside the device. For example, at least one of the synonym frequency DB 204 and the group label DB 207 may be included in an outside server or the like. In this case, the similarity judgement devices 100 and 1600 exchange information with at least one of the synonym frequency DB 204 and the group label DB 207 through the interface 104.

The device of the present embodiment can also be implemented by a computer and a program, and the program can be recorded in a recording medium or provided through a network. Also, each of the above-described devices and their device portions can be implemented either by a hardware configuration or by a combination of hardware resources and software. As the software of the combination configuration, a program is used which is installed in the computer in advance from the network or a computer-readable recording medium (or a storage medium) and executed by a processor of the computer to cause the computer to implement the operation (or function) of each device.

Note that the present invention is not limited to the embodiments described above and can variously be modified at an execution stage within a scope not departing from the gist of the present invention. In addition, each embodiment may be combined as appropriate, and in such a case, combined effects can be obtained. Furthermore, the foregoing embodiments include various inventions, and various inventions can be extracted by combinations selected from a plurality of configuration requirements disclosed herein. For example, in a case where the problem can be solved and effects can be exhibited even if several configuration requirements described in the embodiments are removed from all of the configuration requirements, a configuration with the configuration requirements removed can be extracted as an invention.

### REFERENCE SIGNS LIST

100 Similarity judgement device
101 Processor
102 ROM
103 RAM
104 Interface
105 Display
106 Storage
201 Data acquisition unit
202 Part of speech judgement unit
203 Verb determination unit
204 Synonym frequency DB
205 Object word determination unit
206 Similarity judgement unit
207 Group label DB
208 Update unit
1600 Similarity judgement device
1601 Update unit
1602 Decision result presentation unit
1603 Update input unit

1. A judgement device, comprising:
acquisition circuitry configured to acquire data of a sentence consists of at least two words;
determination circuitry configured to determines a verb and an object word from among words included in the data;
judgement circuitry configured to refer to group label information in which a word included in a label representing a sentence representative of a group including one or more sentences having the same meaning indicates either a verb or an object word and judge which label a synonym of the determined verb and a synonym of the determined object word correspond to; and
update circuitry configured to update the group label information by associating the sentence with the judged label when it can be judged which label a synonym of the verb and a synonym of the object word correspond to.

2. The judgement device according to claim 1, further comprising:
presentation circuitry configured to present data of the sentence and the group label information when it cannot be judged which label at least one of a synonym of the verb and a synonym of the object word corresponds to; and
input circuitry configured to receive a label matching the sentence when a label matching the sentence is present in the group label information, and receive a new label matching the sentence when a label matching the sentence is not present in the group label information, wherein
the update circuitry registers the verb or the object word corresponding to a label matching the sentence as a synonym of a verb or a synonym of an object word of a label matching the sentence, and newly associates the matching label, the sentence, the verb and the object word with group label information to register them.

3. The judgement device according to claim 1, wherein:
the determination circuitry refers to synonym frequency information including a first frequency indicating whether a word is used as either a verb or an object word for each word and a second frequency indicating a sum of the first frequency for each group of one or more words to be a synonym, and determines the verb and the object word from among words included in the data.

4. The judgement device according to claim 3, wherein:
when a word included in the data is included in the group, the determination circuitry determines which of the two words is a verb or an object word by comparing second frequencies of the two words.

5. The judgement device according to claim 3, wherein:
the judgement circuitry refers to the group label information including the two words, a verb included in the two words, an object word included in the two words, the label corresponding to the two words, a verb label that is a verb included in the label, and an object word label that is an object word included in the label, and judges which verb label and which object word label included in the group label information a synonym of a word included in the synonym frequency information to which the determined verb corresponds and a synonym of a word included in the synonym frequency information to which the determined object word corresponds correspond to.

6. The judgement device according to claim 5, wherein:
when it is judged which label the verb and the object word correspond to, the update circuitry associates the determined verb with a verb label judged to correspond, associates the determined object word with an object word label judged to correspond, and associates the judged verb label and a label including the judged object word with the sentence.

7. A judgement method, comprising:
acquiring data of a sentence consists of at least two words;
determining a verb and an object word from among words included in the data;
referring to group label information indicating whether a word included in a label representing a sentence representative of a group including one or more sentences having the same meaning is a verb or an object word to judge which label a synonym of the determined verb and a synonym of the determined object word correspond to; and
associating the sentence with the judged label to update the group label information when it can be judged which label a synonym of the verb and a synonym of the object word correspond to.

8. A non-transitory computer readable medium storing a program for causing a computer to function as each of the circuitries of claim 1.

9. A non-transitory computer readable medium storing a program for causing a computer to perform the judgment method of claim 7.
